(19) United States
(12) Patent Application Publication
(10) Pub. No.: US 2006/0226371 A1
(43) Pub. Date: Oct. 12, 2006

(54) Ultraviolet Detection Device For A Mobile Communication Device

(76) Inventors: Chih-Hung Lu, Hsin-Chu Hsien (TW); Sen-Huang Huang, Hsin-Chu Hsien (TW); Chin-Hsin Yang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,704

(22) Filed: Apr. 12, 2005

(51) Int. Cl. G01J 1/42

(52) U.S. Cl. 250/372

(57) ABSTRACT

An ultraviolet detection device for a mobile communication device includes an ultraviolet data receiver for receiving ultraviolet data; an ultraviolet decision module for determining an ultraviolet index according to ultraviolet data received by the ultraviolet data receiver; and an output module for outputting signals to the mobile communication device according to the ultraviolet index determined by the ultraviolet decision module.

### BACKGROUND OF INVENTION

1. Field of the Invention

The present invention provides a UV detection device for a mobile communication device, and more particularly, a UV detection device capable of alarming a user.

2. Description of the Prior Art

Development of science and technology not only brings human beings a comfortable life, but also changes nature. Due to the deterioration of the ozone layer, damage caused by ultraviolet (UV) rays has received a lot of attention. According to scientific research, exposure to too many UV rays may damage a human's skin and sight. For example, after being irradiated with strong UV rays, the epidermis produces chemical media and releases the chemical media to the derma, causing blood vessel dilatation and erythema on the skin. As research of medical science shows, the erythema caused by UV rays is different from that caused by a burn. The erythema caused by UV rays disappears very slowly, and may turn into black spots or induce skin cancer. Moreover, strong UV rays also damage eye tissue, cause conjunctivitis, keratitis, and damage crystalline lenses, which are reasons that induce cataracts. Therefore, preventing from being irradiated with too many UV rays is the best way to help prevent cataracts. However, except for UV predictions provided by a weather bureau, there are no other credable and referable UV indexes. Furthermore, although strong UV rays are usually present on sunny days, people may also suffer from too much exposure to UV rays on a cloudy day or even indoors. In addition, some lamps also emit UV rays, so UV threats are everywhere in our daily life.

So, if UV rays can be detected anytime and anywhere with a mobile device and be reported through the signaling elements of the mobile device, people can protect themselves at the right moment, so as to prevent UV threats.

### SUMMARY OF INVENTION

It is therefore a primary objective of the claimed invention to provide UV detection devices.

The present invention discloses an ultraviolet detection device for a mobile communication device, which includes an ultraviolet data receiver for receiving ultraviolet data; an ultraviolet decision module for determining an ultraviolet index according to ultraviolet data received by the ultraviolet data receiver; and an output module for outputting signals to the mobile communication device according to the ultraviolet index determined by the ultraviolet decision module.

The present invention further discloses a mobile communication device capable of detecting ultraviolet rays and generating an alert, the device including a housing; a mobile communication module for performing mobile communication; and an ultraviolet detection device. The ultraviolet detection device includes an ultraviolet data receiver for receiving ultraviolet data; an ultraviolet decision module for determining an ultraviolet index according to ultraviolet data received by the ultraviolet data receiver; and an output module for outputting signals according to the ultraviolet index determined by the ultraviolet decision module.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 and FIG. 2 illustrate block diagrams of UV detection devices for mobile communication devices in accordance with the present invention.

### DETAILED DESCRIPTION

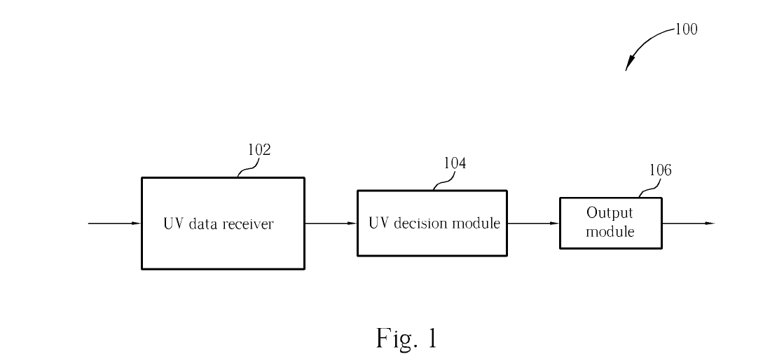

Please refer to FIG. 1, which illustrates a block diagram of a UV detection device 100 for a mobile communication device in accordance with the present invention. The mobile communication device can be a mobile phone, a personal digital assistant, or other electric devices with a function of mobile communication. The UV detection device 100 includes a UV data receiver 102, a UV decision module 104, and an output module 106. The UV data receiver 102 receives UV data, then the UV decision module 104 determines a UV index according to UV data received by the UV data receiver 102, and transmits the UV index to the mobile communication device through the output module 106. The UV detection device 100 can be embedded in the mobile communication device, or the UV detection device 100 can be disposed outside the mobile communication and coupled to the mobile communication device through a wire or a wireless connection.

In FIG. 1, a design of the UV data receiver 102 is not limited as long as the UV data receiver 102 can receive UV data from a particular location of the mobile communication device. For example, the UV data receiver 102 is formed by a passive sensing circuit, which can measure aUV strength at the location. Moreover, in a mobile communication system, the mobile communication device exchanges signals through a nearest available base station, so the UV detection device 100 recognizes a rough location of the mobile communication, and then the UV data receiver 102 can receive UV data through a mobile communication network according to the rough location. Furthermore, the UV data receiver 102 can receive UV data through a global positioning system. Therefore, according to UV data received by the UV data receiver 102, the UV decision module 104 can determine the UV index, and output corresponding signals through the output module 106.

As mentioned above, too many UV rays may hurt a human's skin and eyesight, so the present invention can further include alarm functions for indicating strong UV rays. Then, a calibration module is included for calibrating the UV decision module.

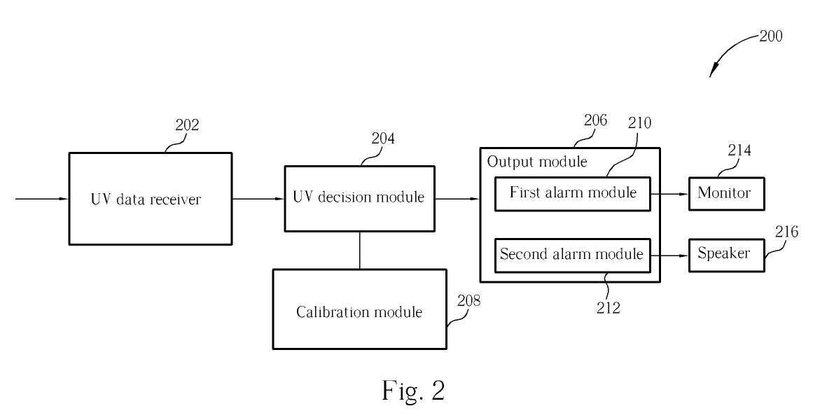

Please refer to FIG. 2, which illustrates a block diagram of a UV detection device 200 for a mobile communication device in accordance with the present invention. The UV detection device 200 includes a UV data receiver 202, a UV decision module 204, an output module 206, and a calibration module 208. The UV data receiver 202 receives UV data, then the UV decision module 204 determines a UV index according to UV data received by the UV data receiver 202, and transmits the UV index to the mobile communication device through the output module 206. The calibration module 208 is used for calibrating the UV decision module 204. The output module 206 includes a first alarm module 210 and a second alarm module 212. When the mobile communication device receives too many UV rays, the UV detection device 200 outputs a visual alarm signal (such as a flash or specific words) to a monitor 214 of the mobile communication device through the first alarm module 210 of the output module 206, or outputs an auditory alarm signal (such as a ring) to a speaker 216 of the mobile communication device through the second alarm module 212 of the output module 206. Therefore, when receiving too many UV rays, the UV detection device 200 can alarm a user through the monitor 214 or the speaker 216.

Certainly, the UV data receiver 202 can be one of many designs as long as the UV data receiver 202 can receive UV data of the location of the mobile communication device. The calibration module 208 can be embedded in the UV detection device 200, or outside the UV detection device 200 and couple to the UV detection device 200 through a wire or a wireless connection.

In summary, the present invention can detect UV rays and alarm a user when too many UV rays come, so as to prevent the user from being hurt by UV rays.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ultraviolet detection device for a mobile communication device comprising:
an ultraviolet data receiver for receiving ultraviolet data;
an ultraviolet decision module for determining an ultraviolet index according to ultraviolet data received by the ultraviolet data receiver; and
an output module for outputting signals to the mobile communication device according to the ultraviolet index determined by the ultraviolet decision module.

2. The ultraviolet detection device of claim 1, wherein the ultraviolet data receiver is a passive sensing circuit.

3. The ultraviolet detection device of claim 1, wherein the ultraviolet data receiver is capable of receiving ultraviolet data of a location of the mobile communication device through a network.

4. The ultraviolet detection device of claim 1, wherein the ultraviolet data receiver is capable of receiving ultraviolet data through a global positioning system.

5. The ultraviolet detection device of claim 1, wherein the ultraviolet decision module comprises an analog to digital converter for transforming data received by the ultraviolet data receiver into digital data.

6. The ultraviolet detection device of claim 1, wherein the output module comprises a first alarm module for outputting a visual alarm signal according to the ultraviolet index determined by the ultraviolet decision module.

7. The ultraviolet detection device of claim 6, wherein the first alarm module outputs the visual alarm signal through a monitor of the mobile communication device.

8. The ultraviolet detection device of claim 1, wherein the output module comprises a second alarm module for outputting an auditory alarm signal according to the ultraviolet index determined by the ultraviolet decision module.

9. The ultraviolet detection device of claim 8, wherein the second alarm module outputs the auditory alarm signal through a speaker of the mobile communication device.

10. The ultraviolet detection device of claim 1 further comprising a calibration module for calibrating the ultraviolet decision module.

11. The ultraviolet detection device of claim 1, wherein the ultraviolet detection device is disposed outside the mobile communication device.

12. The ultraviolet detection device of claim 1, wherein the ultraviolet detection device is embedded in the mobile communication device.

13. The ultraviolet detection device of claim 1, wherein the mobile communication device is a mobile phone.

14. The ultraviolet detection device of claim 1, wherein the mobile communication device is a personal digital assistant.

15. A mobile communication device capable of detecting ultraviolet rays and generating an alert, the device comprising:
a housing;
a mobile communication module for performing mobile communication; and
an ultraviolet detection device comprising:
an ultraviolet data receiver for receiving ultraviolet data;
an ultraviolet decision module for determining an ultraviolet index according to ultraviolet data received by the ultraviolet data receiver; and
an output module for outputting signals according to the ultraviolet index determined by the ultraviolet decision module.

16. The mobile communication device of claim 15, wherein the ultraviolet data receiver is a passive sensing circuit.

17. The mobile communication device of claim 15, wherein the ultraviolet data receiver is capable of receiving ultraviolet data of a location of the mobile communication device through a network.

18. The mobile communication device of claim 15, wherein the ultraviolet data receiver is capable of receiving ultraviolet data through a global positioning system.

19. The mobile communication device of claim 15, wherein the ultraviolet decision module comprises an analog to digital converter for transforming data received by the ultraviolet data receiver into digital data.

20. The mobile communication device of claim 15, wherein the output module comprises a first alarm module for outputting a visual alarm signal according to the ultraviolet index determined by the ultraviolet decision module.

21. The mobile communication device of claim 15, wherein the output module comprises a second alarm module for outputting an auditory alarm signal according to the ultraviolet index determined by the ultraviolet decision module.

22. The mobile communication device of claim 15 further comprising a calibration module for calibrating the ultraviolet decision module.

23. The mobile communication device of claim 15, wherein the ultraviolet detection device is disposed outside the housing.

24. The mobile communication device of claim 15, wherein the ultraviolet detection device is embedded in the housing.

25. The mobile communication device of claim 15 being a mobile phone.

26. The mobile communication device of claim 15 being a personal digital assistant.
